(19) United States
(12) Patent Application Publication
(10) Pub. No.: US 2026/0264224 A1
(43) Pub. Date: Sep. 10, 2026

(54) DRIVE DEVICE, JOINT DEVICE, AND GRIPPING DEVICE

(71) Applicant: SONY GROUP CORPORATION, TOKYO (JP)

(72) Inventors: KIYOKAZU MIYAZAWA, TOKYO (JP); TETSUYA NARITA, TOKYO (JP); YOSHIKAZU FURUYAMA, TOKYO (JP); SATOKO MIZUTANI, TOKYO (JP); WATARU KOKUBO, TOKYO (JP)

(21) Appl. No.: 19/166,385

(22) PCT Filed: Mar. 18, 2024
(86) PCT No.: PCT/JP2024/010449

§ 371 Date: Sep. 17, 2025

(30) Foreign Application Priority Data
Mar. 30, 2023 (JP) 2023-055519

(51) Int. Cl. B25J 9/12; F16H 19/08; H02K 7/116; H02K 11/21; H02K 11/24; H02K 11/33

(52) U.S. Cl. CPC B25J 9/126; F16H 19/08; H02K 7/116; H02K 11/21; H02K 11/24; H02K 11/33; H02K 2211/03

(57) ABSTRACT

A drive device includes: a motor having a rotating drive shaft; a speed reducer coupled to the motor on one side along a central axis of the drive shaft; an encoder coupled to the motor on another side along the central axis; a speed reducer side bracket coupled to the speed reducer and having a speed reducer side extension portion extending in a first direction perpendicular to the central axis; an encoder side bracket coupled to the encoder and having an encoder side extension portion extending in the first direction; a substrate bracket provided between the speed reducer side extension portion and the encoder side extension portion, coupled to the speed reducer side extension portion and the encoder side extension portion, and having a facing surface facing the motor; a first substrate mounted on the facing surface; and a second substrate mounted on a back surface that is a back side of the facing surface.

### FIELD

The present disclosure relates to a drive device, a joint device, and a gripping device used in a robot.

### BACKGROUND

There is an increasing demand for robots that grip and carry objects instead of people. Such a robot includes a finger portion that causes a drive device to rotate joint portions rotatably connected to each other to grip and transport an object (see Patent Literature 1).

### CITATION LIST

### Patent Literature

Patent Literature 1: JP 2021-153858 A.

### SUMMARY

### Technical Problem

In Patent Literature 1, a servo amplifier substrate for driving an actuator provided at the joint portion is provided at a position away from the joint portion. Therefore, for example, in a case where the actuator provided at the joint portion is replaced with an actuator having a large output in order to increase a force for gripping an object, the replacement of the substrate and the replacement of the actuator need to be separately performed, and workability is deteriorated.

On the other hand, it is also conceivable to arrange the actuator at the base of the finger portion and collectively arrange the actuator and the substrate so that the actuator and the substrate can be collectively replaced. In this case, a transmission mechanism for transmitting a driving force of the actuator to rotationally drive the joint portion is required, and a structure of the finger portion becomes complicated.

Therefore, the present disclosure proposes a drive device that is reduced in size and improved in replacement workability.

### Solution to Problem

A drive device of the first aspect of the present technology includes: a motor having a rotating drive shaft; a speed reducer coupled to the motor on one side along a central axis of the drive shaft; an encoder coupled to the motor on another side along the central axis; a speed reducer side bracket coupled to the speed reducer and having a speed reducer side extension portion extending in a first direction perpendicular to the central axis; an encoder side bracket coupled to the encoder and having an encoder side extension portion extending in the first direction; a substrate bracket provided between the speed reducer side extension portion and the encoder side extension portion, coupled to the speed reducer side extension portion and the encoder side extension portion, and having a facing surface facing the motor; a first substrate mounted on the facing surface; and a second substrate mounted on a back surface that is a back side of the facing surface.

### BRIEF DESCRIPTION OF DRAWINGS

FIG. 1 is a diagram illustrating a schematic configuration of a drive device according to a first embodiment of the present disclosure.

FIG. 2 is a cross-sectional view of the drive device according to the first embodiment.

FIG. 3 is a partially enlarged cross-sectional view enlarging a speed reducer side bearing portion in the first

FIG. 4 is a diagram of a torque sensor according to the first embodiment as viewed from one side.

FIG. 5 is a perspective view of the torque sensor according to the first embodiment.

FIG. 6 is a diagram illustrating a schematic configuration of a joint device in which the drive devices according to the first embodiment are coupled.

FIG. 7 is a front view illustrating a schematic configuration of a gripping device using the drive device according to the first embodiment.

FIG. 8 is a side view illustrating a schematic configuration of the gripping device using the drive device according to the first embodiment.

FIG. 9 is a side view illustrating a modification of a gripping device using the drive device according to the first embodiment.

### DESCRIPTION OF EMBODIMENTS

Hereinafter, embodiments of the present disclosure will be described in detail with reference to the drawings. Note that a pallet according to the present disclosure is not limited by the embodiment. In addition, in the present specification and the drawings, components having substantially the same functional configuration are basically denoted by the same reference numerals, and redundant description is omitted.

One or more embodiments described below can each be implemented independently. On the other hand, at least some of the plurality of embodiments described below may be appropriately combined with at least some of the other embodiments. The plurality of embodiments may include novel features different from each other. Therefore, the plurality of embodiments can contribute to solving different objects or problems, and can exhibit different effects.

The present disclosure will be described according to the following order of items.

1. First Embodiment

1-1. Outline of Drive Device

1-1-1. Configuration of Motor

1-1-2. Configuration of Speed Reducer

1-1-3. Configuration of Encoder

1-1-4. Configuration of Torque Sensor

1-1-5. Configuration of Speed Reducer Side Bracket

1-1-6. Configuration of Encoder Side Bracket

1-1-7. Configuration of Substrate Bracket

1-1-8. Configuration of First Substrate

1-1-9. Configuration of Second Substrate

1-1-10. Configuration of External Bearing

2. Joint Device in Which Drive Devices According to First Embodiment are Coupled

3. Gripping Device Using Drive Device According to First Embodiment

4. Modification of Gripping Device Using Drive Device According to First Embodiment

5. Effects of Drive Device According to First Embodiment, and Joint Device and Gripping Device Using the Drive Device

6. Appendix

### 1. First Embodiment

### <1-1. Outline of Drive Device>

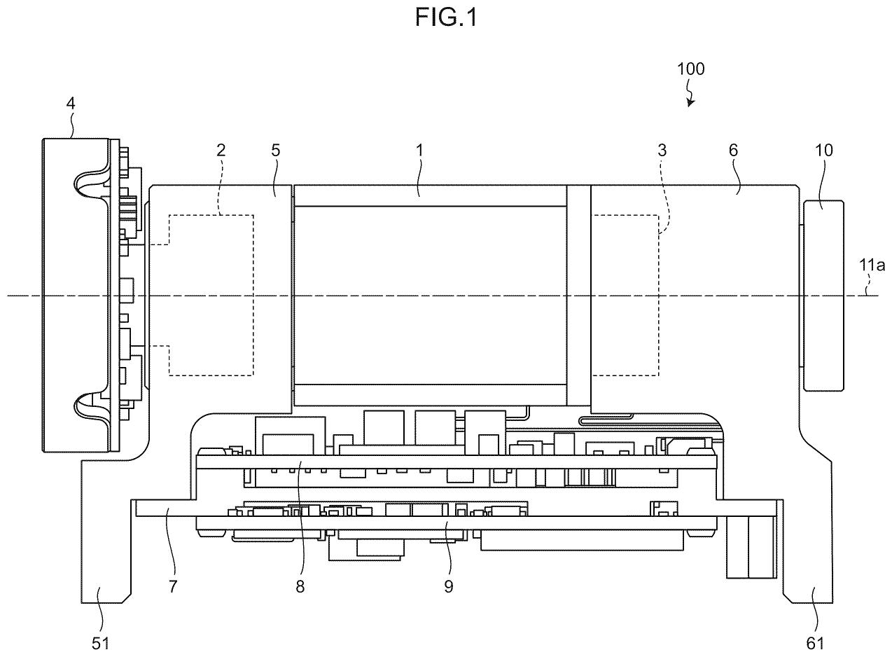

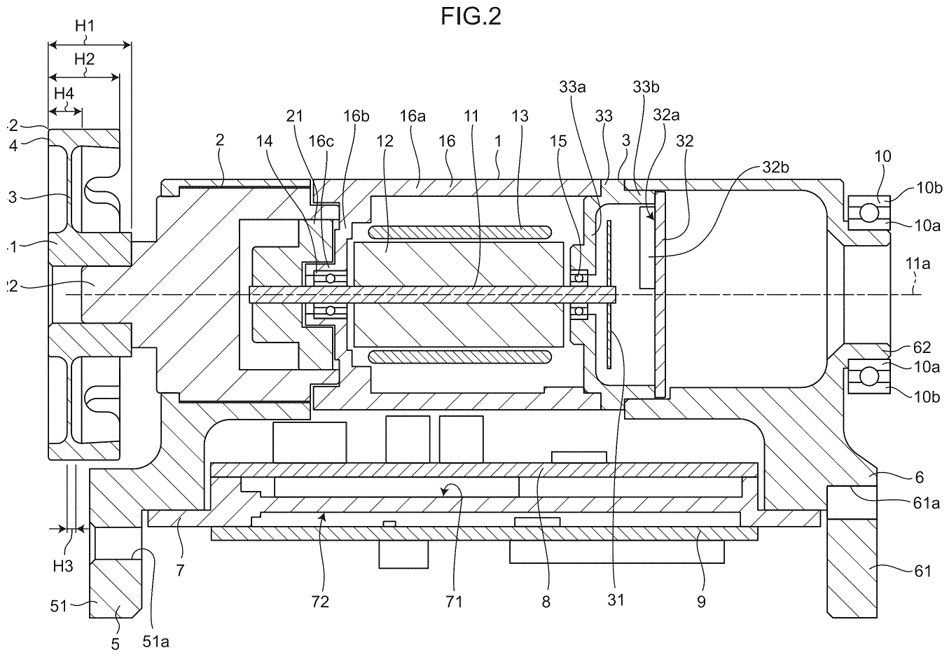

FIG. 1 is a diagram illustrating a schematic configuration of a drive device according to a first embodiment of the present disclosure. FIG. 2 is a cross-sectional view of the drive device according to the first embodiment. A drive device 100 according to the first embodiment includes a motor 1, a speed reducer 2, an encoder 3, a torque sensor 4, a speed reducer side bracket 5, an encoder side bracket 6, a substrate bracket 7, a first substrate 8, a second substrate 9, and an external bearing 10.

### <1-1-1. Configuration of Motor>

The motor 1 is sandwiched between the speed reducer 2 and the encoder 3. In the following description, the speed reducer 2 side as viewed from the motor 1 is referred to as one side, and the encoder 3 side as viewed from the motor 1 is referred to as another side.

As illustrated in FIG. 2, the motor 1 includes a drive shaft 11, a movable portion 12, a stator 13, a speed reducer side bearing 14, an encoder side bearing 15, and a motor casing 16.

The drive shaft 11 is a rod-shaped member formed in a columnar shape. The movable portion 12 is provided to surround the drive shaft 11 and is fixed to the drive shaft 11. The stator 13 is formed in a cylindrical shape and is provided so as to surround the movable portion 12. A gap is provided between the stator 13 and the movable portion 12.

The speed reducer side bearing 14 rotatably supports the drive shaft 11 on the one side of the movable portion 12. The encoder side bearing 15 rotatably supports the drive shaft 11 on the other side of the movable portion 12. The drive shaft 11 is supported by the speed reducer side bearing 14 and the encoder side bearing 15 to be rotatable about a central axis 11a extending in a longitudinal direction.

The motor casing 16 accommodates the movable portion 12, the stator 13, the speed reducer side bearing 14, and the encoder side bearing 15 therein to constitute an outer shell of the motor 1. The motor casing 16 includes a cylindrical portion 16a that surrounds the stator 13 formed in the cylindrical shape, and a lid 16b that closes an opening on the one side of the cylindrical portion 16a. The motor casing 16 is a framework made of metal or resin.

In the lid 16b, the speed reducer side bearing 14 is fitted from the inside, and a protrusion 16c protruding toward the speed reducer 2 is formed on the outside. In this manner, the speed reducer side bearing 14 is fixed to the motor casing 16. Note that, as will be described in detail later, the encoder side bearing 15 that supports the drive shaft 11 on the other side is fixed to the encoder 3.

When current is supplied to the motor 1, the movable portion 12 and the drive shaft 11 rotate.

### <1-1-2. Configuration of Speed Reducer>

The speed reducer 2 reduces rotation speed of the drive shaft 11 of the motor 1 and outputs the reduced rotation speed. In the first embodiment, an example in which the speed reducer 2 is a wave gear speed reducer will be described, but other speed reducers may be used. The speed reducer 2 includes a wave generator 21 and an output shaft 22. The wave generator 21 is provided on the one side of the lid 16b of the motor casing 16. The wave generator 21 is fixed to the drive shaft 11 protruding from the lid 16b, and rotates together with the drive shaft 11. The wave generator 21 has an elliptical cross-sectional shape cut along a plane perpendicular to the drive shaft 11. Although detailed description of the configuration is omitted, in the speed reducer 2 which is the wave gear speed reducer, when the wave generator 21 rotates together with the drive shaft 11, the output shaft 22 rotates at a rotation speed lower than the rotation speed of the drive shaft 11.

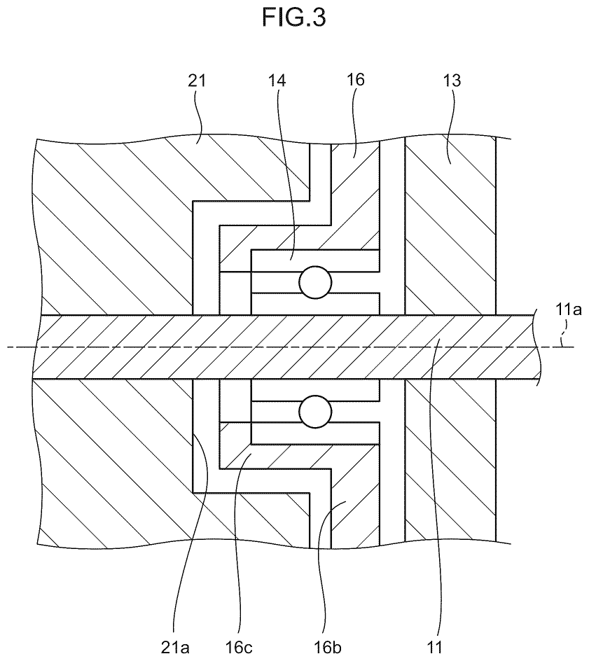

FIG. 3 is a partially enlarged cross-sectional view enlarging a speed reducer side bearing portion in the first embodiment. The wave generator 21 is formed with a recess 21a which the protrusion 16c formed in the motor casing 16 enters. A gap is formed between the protrusion 16c and the recess 21a, and the rotation of the wave generator 21 is not hindered by the protrusion 16c.

### <1-1-3. Configuration of Encoder>

The encoder 3 detects a rotational speed and a rotational position of the drive shaft 11. The encoder 3 includes a disk 31, an encoder substrate 32, and an encoder casing 33. The disk 31 is fixed to the drive shaft 11 on the other side of the stator 13. The disk 31 rotates together with the drive shaft 11.

The encoder substrate 32 is provided on the other side with respect to the disk 31. The encoder substrate 32 has a facing surface 32a facing the disk 31. A detection unit 32b is provided on the facing surface 32a. The detection unit 32b detects the rotational speed and the rotational position of the drive shaft 11 by detecting a rotational speed and a rotational position of the disk 31. A value detected by the detection unit 32b is transmitted toward the second substrate 9. A detection method by the detection unit 32b is not particularly limited, and may be, for example, an optical type or a magnetic type.

The encoder casing 33 includes a lid 33a that closes an opening on the other side of the motor casing 16, and a substrate support portion 33b that protrudes to the other side from an outer edge of the lid 33a and supports the encoder substrate 32. The encoder casing 33 is a framework made of metal or resin. The encoder side bearing 15 of the motor 1 is fixed to the lid 33a of the encoder casing 33.

Since the lid 33a of the encoder casing 33 closes the opening of the motor casing 16, it can be said that the lid constitutes a part of the motor 1. That is, in the first embodiment, the encoder casing 33 has both a function on the motor 1 side of closing the opening of the motor casing 16 and fixing the encoder side bearing 15, and a function on the encoder 3 side of supporting the encoder substrate 32.

### <1-1-4. Configuration of Torque Sensor>

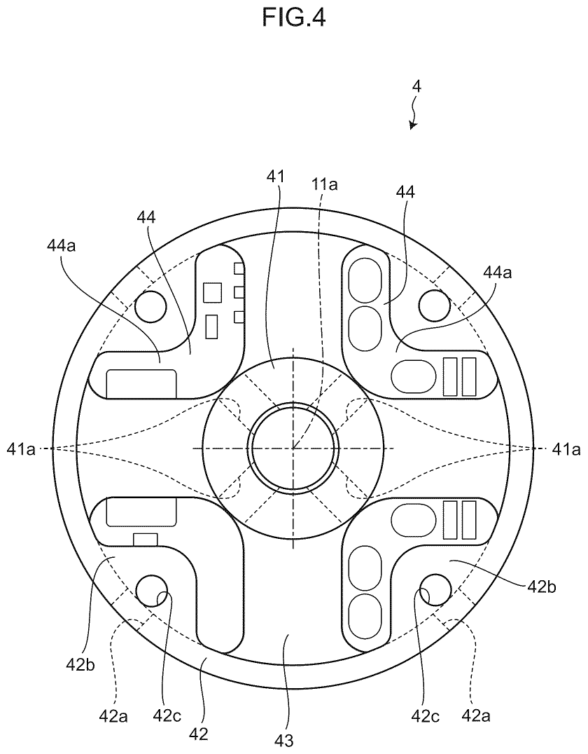

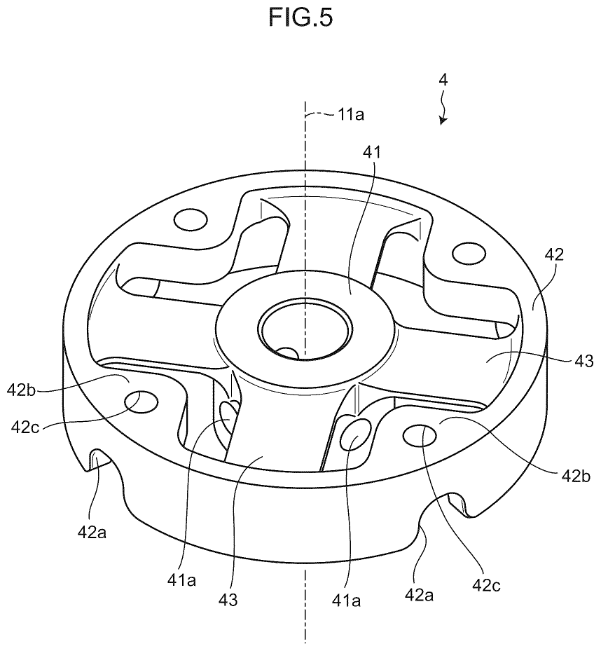

The torque sensor 4 detects torque applied to the output shaft 22 of the speed reducer 2. FIG. 4 is a diagram of the torque sensor according to the first embodiment as viewed from the one side. FIG. 5 is a perspective view of the torque sensor according to the first embodiment.

The torque sensor 4 includes a boss portion 41, an annular portion 42, a beam portion 43, and a strain detection unit 44. The boss portion 41 is formed in an annular shape centered on the central axis 11a, and the output shaft 22 of the speed reducer 2 is fitted inside. Four through holes 41a penetrating an inner peripheral surface and an outer peripheral surface are formed in the boss portion 41. The four through holes 41a are formed side by side at equal intervals in a circumferential direction. A screw thread is formed on an inner peripheral surface of the through hole 41a. The boss portion 41 is fixed to the output shaft 22 by screwing a set screw (not illustrated) into the through hole 41a.

The annular portion 42 is formed in an annular shape centered on the central axis 11a and surrounds a periphery of the boss portion 41. The beam portion 43 is provided across the outer peripheral surface of the boss portion 41 and an inner peripheral surface of the annular portion 42. A penetrating portion 42a penetrating an outer peripheral surface and the inner peripheral surface is formed in the annular portion 42. In the first embodiment, an example in which the penetrating portion 42a is formed by a cutout is illustrated, but the penetrating portion 42a may be formed by a hole. The penetrating portion 42a is formed at a position where the through hole 41a formed in the boss portion 41 is projected onto the annular portion 42 along a penetrating direction.

The beam portion 43 is connected to the outer peripheral surface of the boss portion 41 and the inner peripheral surface of the annular portion 42, and the beam portion 43, the boss portion 41, and the annular portion 42 are integrally formed. The plurality of beam portions 43 is formed side by side in the circumferential direction around the central axis 11a. In the first embodiment, four beam portions 43 are formed. The four beam portions 43 are formed side by side at equal intervals. A thickness H3 of the beam portion 43 in a direction along the central axis 11a is smaller than a thickness H1 of the boss portion 41 and a thickness H2 of the annular portion 42.

When viewed along the central axis 11a, an extending direction of the beam portion 43 and the penetrating direction of the through hole 41a are shifted from each other. An inner peripheral surface protrusion 42b protruding toward the boss portion 41 is formed at a portion between the plurality of beam portions 43 on the inner peripheral surface of the annular portion 42. A thickness H4 of the inner peripheral surface protrusion 42b is thicker than the thickness H3 of the beam portion 43. A hole 42c penetrating in the direction along the central axis 11a is formed in the inner peripheral surface protrusion 42b. A screw thread is formed on an inner peripheral surface of the hole 42c.

The strain detection unit 44 detects strain of the beam portion 43. The strain detection unit 44 includes a strain gauge (not illustrated) attached to the beam portion 43 and a detection substrate 44a that detects a change in a voltage value based on strain of the strain gauge. Note that, in FIG. 5, the detection substrate 44a of the strain detection unit 44 is not illustrated in order to facilitate understanding of a shape of the beam portion 43. When the output shaft 22 of the speed reducer 2 rotates to rotate the torque sensor 4, strain is generated in the beam portion 43. The strain detection unit 44 detects the strain of the beam portion 43. Magnitude of the strain is proportional to magnitude of the torque applied to the output shaft 22. A value detected by the strain detection unit 44 is transmitted toward the second substrate 9.

Note that the number of beam portions 43, through holes 41a, penetrating portions 42a, and inner peripheral surface protrusions 42b provided in the torque sensor 4 is not limited to the number exemplified in the above description.

### <1-1-5. Configuration of Speed Reducer Side Bracket>

Returning to FIGS. 1 and 2, the speed reducer side bracket 5 is connected to the speed reducer 2. The speed reducer side bracket 5 is connected to a housing (not illustrated) of the speed reducer 2 and does not interlock with the rotation of the wave generator 21 and the output shaft 22. The speed reducer side bracket 5 is a framework made of metal or resin. The speed reducer side bracket 5 has a speed reducer side extension portion 51 extending in a direction perpendicular to the central axis 11a. A through hole 51a penetrating in the direction along the central axis 11a is formed in the speed reducer side extension portion 51.

### <1-1-6. Configuration of Encoder Side Bracket>

The encoder side bracket 6 is coupled to the encoder 3. More specifically, the encoder side bracket 6 is coupled to the encoder casing 33 of the encoder 3. The encoder side bracket 6 is a framework made of metal or resin. The encoder side bracket 6 has an encoder side extension portion 61 extending in the direction perpendicular to the central axis 11a. A through hole 61a penetrating in the direction along the central axis 11a is formed in the encoder side extension portion 61.

### <1-1-7. Configuration of Substrate Bracket>

The speed reducer side extension portion 51 and the encoder side extension portion 61 described above face each other. The substrate bracket 7 is provided between the speed reducer side extension portion 51 and the encoder side extension portion 61 facing each other. The substrate bracket 7 is connected to the speed reducer side extension portion 51 and the encoder side extension portion 61. The substrate bracket 7 is connected to the speed reducer side extension portion 51 and the encoder side extension portion 61 by screws or bolts (not illustrated). The substrate bracket 7 is a framework made of metal or resin. The substrate bracket 7 has a facing surface 71 facing the motor 1.

### <1-1-8. Configuration of First Substrate>

The first substrate 8 is mounted on the facing surface 71 of the substrate bracket 7. A plurality of electronic components is mounted on the first substrate 8. The first substrate 8 is a so-called driver substrate that transmits current to the motor 1 based on a drive command transmitted from the second substrate 9 to be described later.

### <1-1-9. Configuration of Second Substrate>

The second substrate 9 is mounted on a back surface 72 which is a back side of the facing surface 71 of the substrate bracket 7. A plurality of electronic components is mounted on the second substrate 9. The second substrate 9 calculates the rotation speed and the rotational position of the drive shaft 11 of the motor 1 from the value transmitted from the detection unit 32b of the encoder 3. The second substrate 9 calculates the torque applied to the output shaft 22 based on the value transmitted from the strain detection unit 44 of the torque sensor 4. The second substrate 9 is a controller substrate that calculates a current value or the like to be sent to the motor 1 based on the calculated values, and transmits the calculated current value or the like as a command value to the first substrate 8.

### <1-1-10. Configuration of External Bearing>

As illustrated in FIG. 2, a cylindrical portion 62 having a cylindrical shape coaxial with the drive shaft 11 is formed outside the encoder side bracket 6. The external bearing 10 has an inner ring 10a and an outer ring 10b, and the cylindrical portion 62 is fitted inside the inner ring 10a.

### 2. Joint Device in Which Drive Devices According to First Embodiment are Coupled

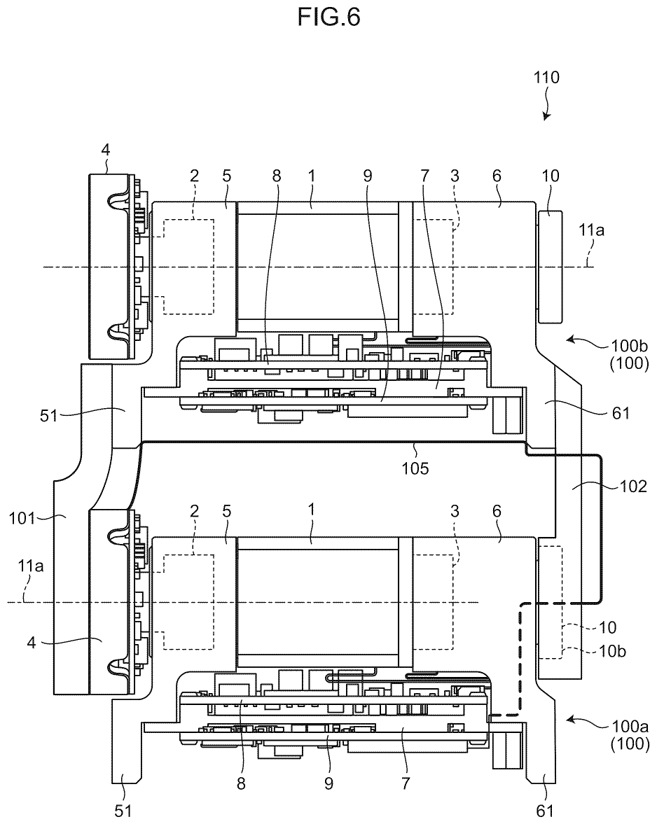

FIG. 6 is a diagram illustrating a schematic configuration of a joint device in which the drive devices according to the first embodiment are coupled. FIG. 6 illustrates a joint device 110 in which the two drive devices 100 are coupled. Regarding the two drive devices 100, one drive device 100 is referred to as a drive device 100a, and another drive device 100 is referred to as a drive device 100b for convenience.

The joint device 110 includes a first coupling bracket 101 and a second coupling bracket 102. The first coupling bracket 101 couples the torque sensor 4 of the drive device 100a and the speed reducer side extension portion 51 of the drive device 100b. The first coupling bracket 101 is fixed to the speed reducer side extension portion 51 with a bolt or the like using the through hole 51a of the speed reducer side extension portion 51. The second coupling bracket 102 couples the outer ring 10b of the external bearing 10 of the drive device 100a and the encoder side extension portion 61 of the drive device 100b. The second coupling bracket 102 is coupled to the encoder side extension portion 61 with a bolt or the like using the through hole 61a of the encoder side extension portion 61.

The first coupling bracket 101 and the second coupling bracket 102 rotate about the central axis 11a when the motor 1 of the drive device 100a is driven. As a result, the drive device 100b in which the first coupling bracket 101 and the second coupling bracket 102 are coupled also rotates about the central axis 11a of the drive device 100a. As a result, the joint device 110 including the drive device 100a and the drive device 100b has a joint structure bent around the central axis 11a of the drive device 100a.

The drive device 100a includes a wiring 45 for transmitting a detection value of the strain detection unit 44 of the torque sensor 4. The wiring 45 is connected to the torque sensor 4 and the second substrate 9. The detection value of the strain detection unit 44 is transmitted to the second substrate 9 via the wiring 45.

In a path of the wiring 45, the wiring is first directed from the torque sensor 4 to the speed reducer side extension portion 51 of the drive device 100b along the first coupling bracket 101. Then, the wiring 45 is directed from the speed reducer side extension portion 51 of the drive device 100b to the encoder side bracket 6 of the drive device 100a via the encoder side extension portion 61 of the drive device 100b along the second coupling bracket 102. Then, the wiring 45 enters the encoder side bracket 6 from the cylindrical portion 62 of the encoder side bracket 6, reaches the second substrate 9, and is connected to the second substrate 9.

As described above, the wiring 45 extending from the one drive device 100a passes through the other drive device 100b, so that the wiring path can be formed in a U shape as illustrated in FIG. 6. By forming the wiring path in the U shape, it is possible to reduce twisting of the wiring 45 and a load applied to the wiring 45 in a case where the joint device 110 is driven as compared with a case where the strain detection unit 44 and the second substrate 9 are linearly connected.

### 3. Gripping Device Using Drive Device According to First Embodiment

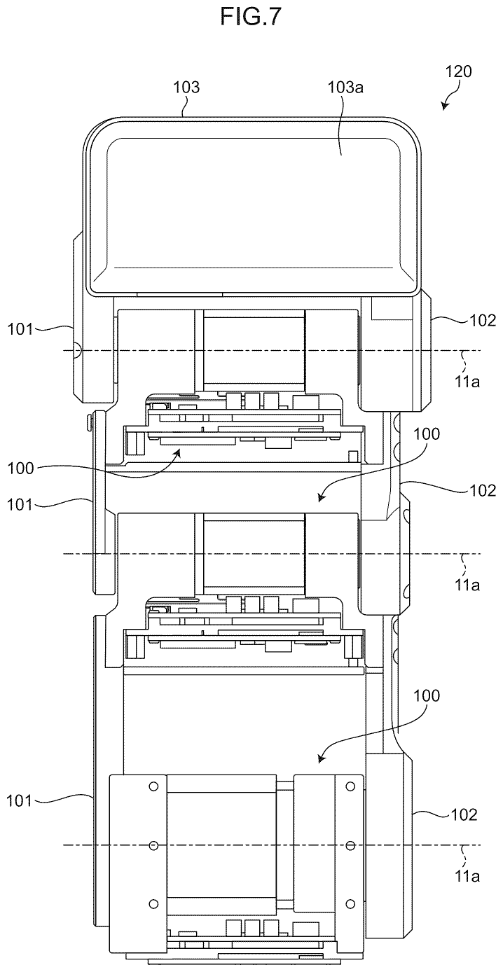

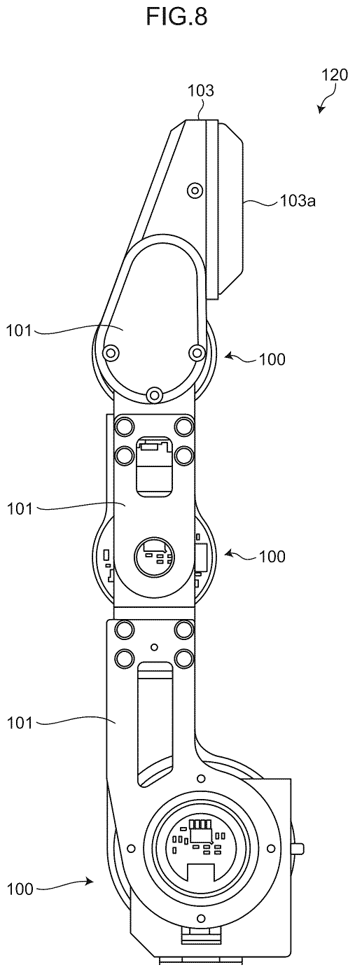

FIG. 7 is a front view illustrating a schematic configuration of a gripping device using the drive device according to the first embodiment. FIG. 8 is a side view illustrating a schematic configuration of the gripping device using the drive device according to the first embodiment. In a gripping device 120 illustrated in FIGS. 7 and 8, a joint device is configured by coupling the three drive devices 100 by the first coupling bracket 101 and the second coupling bracket 102, and a gripping portion 103 is provided in the joint device.

Further, the gripping portion 103 is connected to the drive device 100 (referred to as a drive device 100c) connected to the most distal end. The gripping portion 103 is coupled to the torque sensor 4 of the drive device 100c by the first coupling bracket 101, and is coupled to the external bearing 10 of the drive device 100c by the second coupling bracket 102. The gripping portion 103 rotates about the central axis 11a of the drive device 100c. The gripping portion 103 is provided with a gripping pad 103a. In the gripping device 120, the gripping pad is bent around the central axis 11a of the drive device 100 to abut on a target object and grip the target object. The gripping pad 103a is preferably formed of a flexible member having a higher friction coefficient than other portions of the gripping device 120 in order to reliably grip the target object.

### 4. Modification of Gripping Device Using Drive Device According to First Embodiment

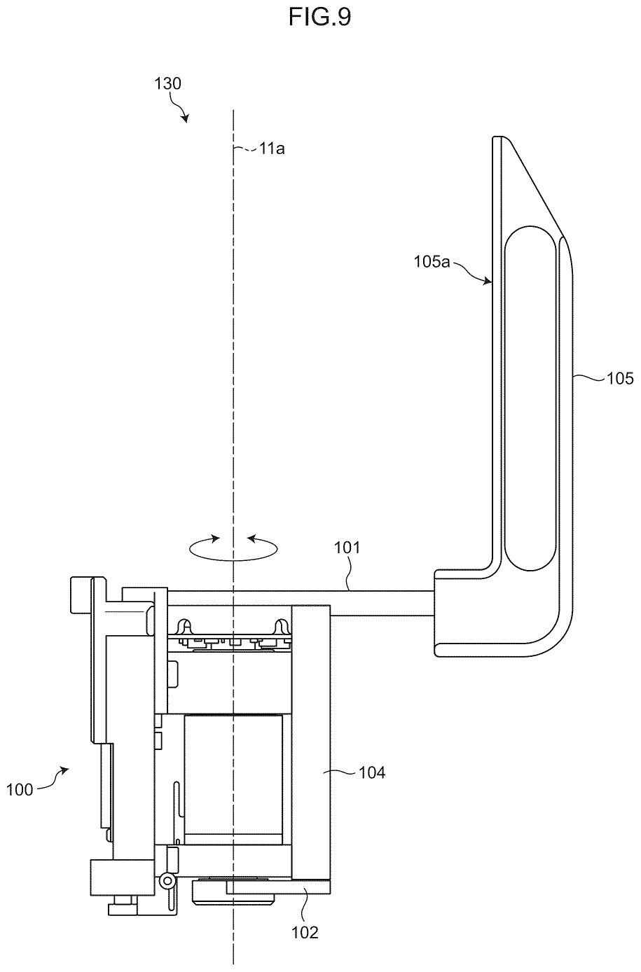

FIG. 9 is a side view illustrating a modification of a gripping device using the drive device according to the first embodiment. In a gripping device 130 according to the modification, a gripping portion 105 is connected to the drive device 100. The gripping portion 105 is coupled to the torque sensor 4 of the drive device 100 by the first coupling bracket 101. The gripping portion 105 extends to the one side along the central axis 11a, and has a gripping surface 105a facing the central axis 11a. As with the gripping device 120 illustrated in FIGS. 7 and 8, the gripping surface 105a may be provided with a gripping pad formed of a flexible member having a higher friction coefficient than other portions.

The first coupling bracket 101 and the second coupling bracket 102 are coupled by an auxiliary bracket 104. Since the auxiliary bracket 104 is provided, the gripping portion 105 is held by the first coupling bracket 101 and the second coupling bracket 102, so that rigidity of the gripping portion 105 is improved.

### 5. Effects of Drive Device According to First Embodiment, and Joint Device and Gripping Device Using the Drive Device

In the drive device 100 according to the first embodiment, the speed reducer 2, the encoder 3, the first substrate 8, and the second substrate 9 for driving and controlling the motor 1 are unitized together with the motor 1 to be controlled. Therefore, in a case where the plurality of drive devices 100 is coupled as illustrated in FIGS. 6 to 8, replacement may be performed in units when some of the drive devices 100 are replaced, and it is not necessary to separately replace the motor 1 and the substrates 8 and 9, so that replacement work can be facilitated.

In addition, in terms of management of components, since the drive device 100 is unitized, for example, as compared with a case where the motor 1, the first substrate 8, and the second substrate 9 are not unitized and must be separately managed, it is possible to facilitate management of components and save a storage space.

In addition, as illustrated in FIGS. 6 to 9, since the plurality of unitized drive devices 100 can be connected to constitute the joint device 110 and the gripping device 120, 130, the motor 1 having the drive shaft 11 is provided at a portion to be bent. Therefore, as in a case where the motor 1 is provided at the root of the joint device or the gripping device, a transmission mechanism that transmits a driving force of the motor 1 to the portion to be bent is unnecessary, and thus, it is possible to simplify the structure and downsize the device.

Further, in the drive device 100 according to the first embodiment, the motor 1, the speed reducer 2, the encoder 3, the speed reducer side bracket 5, and the encoder side bracket 6 are arranged side by side along the central axis 11a and connected to each other. In addition, the speed reducer side extension portion 51 of the speed reducer side bracket 5 and the encoder side extension portion 61 of the encoder side bracket 6 are connected by the substrate bracket 7. With this structure, a quadrangular frame body composed of the frameworks is unitized and formed. As a result, rigidity of the drive device 100 is improved.

As the rigidity of the drive device 100 is improved, for example, when a target object is gripped by the gripping device 120, 130 illustrated in FIGS. 7 to 9, even if a reaction force is applied from the target object, the gripping device 120, 130 is less likely to bend. The bending of the gripping device 120, 130 causes a decrease in gripping force and a decrease in detection accuracy by the torque sensor 4. Therefore, by improving the rigidity by the drive device 100 according to the first embodiment, it is possible to reliably grip the target object by the gripping device 120, 130 using the drive device 100 and to perform precise control based on the torque detected more accurately.

In addition, the first substrate 8 and the second substrate 9 are mounted on the substrate bracket 7 which is a part of the unitized frame body. Therefore, a distance between the first substrate 8 and the second substrate 9 and the frame body other than the substrate bracket 7 becomes short. As a result, heat generated in the first substrate 8 and the second substrate 9 is easily transferred to the frame body, and the heat dissipation is improved.

In addition, since the speed reducer side bearing 14, which is a part of the motor 1, is inserted into the recess 21a of the wave generator 21, a length occupied by the motor 1 and the speed reducer 2 in a length in the direction along the central axis 11a of the entire drive device 100 (hereinafter referred to as a width of the drive device) can be shortened as compared with a configuration in which the speed reducer side bearing 14 is not inserted into the recess 21a. This also contributes to reduction in the width of the drive device 100.

In addition, the encoder casing 33 has both a function on the motor 1 side of closing the opening of the motor casing 16 and fixing the encoder side bearing 15, and a function on the encoder 3 side of supporting the encoder substrate 32. As a result, a length occupied by the motor 1 and the encoder 3 in the entire width of the drive device 100 can be shortened as compared with a case where a member that closes the opening on the other side of the motor casing 16 and a member that supports the encoder substrate 32 are separately provided. This also contributes to shortening the width of the drive device 100.

The length of the motor 1 varies depending on its performance. However, in the drive device 100 according to the first embodiment, as described above, the length occupied by the speed reducer 2 to the encoder 3 in the width of the drive device 100 can be shortened. Therefore, it is easy to form the drive devices 100 having different performances of the motors 1 with a constant width. For example, in the example illustrated in FIG. 2, when the length of the motor 1 increases, the width of the drive device 100 does not need to be changed by shortening the length of the encoder side bracket 6. As described above, by making the width of the drive device 100 constant, the drive devices 100 having different performances of the motors 1, that is, the drive devices 100 having different outputs can be easily recombined, and the degree of freedom in designing the joint device 110 and the gripping device 120, 130 is improved.

In addition, since each component is compactly unitized in the drive device 100, a space is easily secured between the drive devices 100 in the joint device 110 and the gripping device 120, 130. In addition, other components can be arranged in the secured space. Examples of other components include sensors such as a tactile sensor, a proximity sensor, a temperature sensor, and a vibration sensor. In addition, examples of other components include gels and rubbers.

In addition, since the torque sensor 4 detects the torque using the strain of the beam portion 43 whose thickness along the central axis 11a is thinner than those of the boss portion 41 and the annular portion 42, a thickness of the entire torque sensor 4 can be formed thin. Therefore, the length of the drive device 100 in the direction along the central axis 11a can be shortened, and the drive device 100 can be downsized.

Further, the inner peripheral surface protrusion 42b provided in the torque sensor 4 is provided at a position shifted from the penetrating portion 42a in the direction along the central axis 11a. That is, the inner peripheral surface protrusion 42b is formed in the vicinity of the penetrating portion 42a. As a result, reduction in rigidity of the annular portion 42 due to formation of the penetrating portion 42a can be compensated by the inner peripheral surface protrusion 42b, and rigidity of the annular portion 42 can be maintained.

Further, in the torque sensor 4, the penetrating portion 42a is formed at the position where the through hole 41a formed in the boss portion 41 is projected onto the annular portion 42 along the penetrating direction. As a result, when a set screw is screwed into the through hole 41a, the tool can be easily inserted into the through hole 41a through the penetrating portion 42a, so that work of fixing the boss portion 41 is facilitated.

In addition, since the substrate for driving and controlling the motor 1 is divided into the first substrate 8 serving as the driver substrate and the second substrate 9 serving as the controller substrate, the size of each substrate can be reduced. Thus, the drive device 100 can be downsized.

In addition, the second substrate 9 serving as the controller substrate is mounted on the back surface 72 not facing the motor 1, so that it is easy to access a component mounting surface of the second substrate 9. Generally, many connectors to which wirings are connected tend to be provided on the component mounting surface of the controller substrate. Therefore, the connector can be easily removed, and workability can be improved when the drive device 100 is replaced or the like. Note that this description does not exclude a configuration in which the first substrate 8 is a controller substrate and the second substrate is a driver substrate.

### 6. Appendix

Note that the present technology can also have the following configurations.

(1) A drive device comprising:

a motor having a rotating drive shaft;

a speed reducer coupled to the motor on one side along a central axis of the drive shaft;

an encoder coupled to the motor on another side along the central axis;

a speed reducer side bracket coupled to the speed reducer and having a speed reducer side extension portion extending in a first direction perpendicular to the central axis;

an encoder side bracket coupled to the encoder and having an encoder side extension portion extending in the first direction;

a substrate bracket provided between the speed reducer side extension portion and the encoder side extension portion, coupled to the speed reducer side extension portion and the encoder side extension portion, and having a facing surface facing the motor;

a first substrate mounted on the facing surface; and

a second substrate mounted on a back surface that is a back side of the facing surface.

(2) The drive device according to (1), wherein

the speed reducer is a wave gear speed reducer including a wave generator,

the motor includes

a speed reducer side bearing that rotatably supports the drive shaft on the one side, and

a motor casing that accommodates the drive shaft therein,

in the motor casing, the speed reducer side bearing is fitted from inside, and a protrusion that protrudes toward the speed reducer is provided, and

a recess which the protrusion enters is formed in the wave generator.

(3) The drive device according to (1) or (2), wherein

the encoder includes

an encoder substrate on which a detection unit that detects a rotational position of the drive shaft is mounted, and

an encoder casing that supports the encoder substrate,

the motor includes an encoder side bearing that rotatably supports the drive shaft on the other side, and

the encoder side bearing is supported by the encoder casing.

(4) The drive device according to any one of (1) to (3), further comprising

a torque sensor fixed to an output shaft of the speed reducer and detecting torque applied to the output shaft, wherein

the torque sensor includes

a boss portion into which the output shaft is fitted,

an annular portion formed in an annular shape centered on the central axis and surrounding a periphery of the boss portion,

a plurality of beam portions connected to an outer peripheral surface of the boss portion and an inner peripheral surface of the annular portion and formed side by side at equal intervals in a circumferential direction around the central axis, and

a strain detection unit that detects strain of the beam portion, and

a thickness of the beam portion in a direction along the central axis is smaller than thicknesses of the boss portion and the annular portion.

(5) The drive device according to (4), wherein

a through hole penetrating the outer peripheral surface and an inner peripheral surface is formed in the boss portion,

a penetrating portion penetrating an outer peripheral surface and the inner peripheral surface is formed in the annular portion, and

the penetrating portion is formed at a position where the through hole is projected onto the annular portion along a penetrating direction.

(6) The drive device according to (5), wherein

when viewed along the central axis, an extending direction of the beam portion and the penetrating direction of the through hole are shifted from each other,

an inner peripheral surface protrusion protruding toward the boss portion is formed at a portion between the plurality of beam portions on the inner peripheral surface of the annular portion, and

a thickness of the inner peripheral surface protrusion is larger than the thickness of the beam portion.

(7) The drive device according to any one of (1) to (6), wherein

the second substrate is a controller substrate that generates a drive command for driving the motor based on a detection result of the encoder, and

the first substrate is a driver substrate that transmits current to the motor based on the drive command.

(8) A joint device comprising:

at least two drive devices according to claim 1 coupled in parallel to the central axis, wherein

a cylindrical portion having a cylindrical shape coaxial with the drive shaft is formed outside the encoder side bracket, and

the joint device further comprises:

an external bearing having an inner ring and an outer ring, the cylindrical portion being fitted inside the inner ring;

a first coupling bracket that couples an output shaft of the speed reducer of the one drive device and a speed reducer side extension portion of the other drive device; and

a second coupling bracket that couples the external bearing of the one drive device and an encoder side extension portion of the other drive device.

(9) The joint device according to (8), wherein

either the first substrate or the second substrate of the one drive device is a controller substrate that generates a drive command for driving the motor based on a detection result of the encoder,

the one drive device further includes

a torque sensor applied to the drive shaft, and

a wiring connected to the controller substrate and the torque sensor of the one drive device, and

the wiring is connected from the torque sensor to at least one of the first substrate and the second substrate of the one drive device via the first coupling bracket, the speed reducer side extension portion of the other drive device, the encoder side extension portion of the other drive device, the second coupling bracket, and the encoder side bracket of the one drive device.

(10) A gripping device comprising:

the joint device according to (8) or (9); and

a gripping portion connected to the other drive device.

(11) A gripping device comprising:

the drive device according to any one of (1) to (7); and

a gripping portion connected to the torque sensor,

extending toward the one side, and having a gripping surface facing the central axis.

### Reference Signs List

1 MOTOR
2 SPEED REDUCER
3 ENCODER
4 TORQUE SENSOR
5 SPEED REDUCER SIDE BRACKET
6 ENCODER SIDE BRACKET
7 SUBSTRATE BRACKET
8 FIRST SUBSTRATE
9 SECOND SUBSTRATE
10 EXTERNAL BEARING
10a INNER RING
10b OUTER RING
11 DRIVE SHAFT
12 MOVABLE PORTION
13 STATOR
14 SPEED REDUCER SIDE BEARING
15 ENCODER SIDE BEARING
16 MOTOR CASING
16a CYLINDRICAL PORTION
16b LID
16c PROTRUSION
21 WAVE GENERATOR
21a RECESS
22 OUTPUT SHAFT
31 DISK
32 ENCODER SUBSTRATE
32a FACING SURFACE
32b DETECTION UNIT
33 ENCODER CASING
33a LID
33b SUBSTRATE SUPPORT PORTION
41 BOSS PORTION
41a THROUGH HOLE
42 ANNULAR PORTION
42a PENETRATING PORTION
42b INNER PERIPHERAL SURFACE PROTRUSION
42c HOLE
43 BEAM PORTION
44 STRAIN DETECTION UNIT
44a DETECTION SUBSTRATE
45 WIRING
51 SPEED REDUCER SIDE EXTENSION PORTION
51a THROUGH HOLE
61 ENCODER SIDE EXTENSION PORTION
61a THROUGH HOLE
62 CYLINDRICAL PORTION
71 FACING SURFACE
72 BACK SURFACE
100, 100a, 100b DRIVE DEVICE
101 FIRST COUPLING BRACKET
102 SECOND COUPLING BRACKET
103, 105 GRIPPING PORTION
103a GRIPPING PAD
110 JOINT DEVICE
120, 130 GRIPPING DEVICE

1. A drive device comprising:
a motor having a rotating drive shaft;
a speed reducer coupled to the motor on one side along a central axis of the drive shaft;
an encoder coupled to the motor on another side along the central axis;
a speed reducer side bracket coupled to the speed reducer and having a speed reducer side extension portion extending in a first direction perpendicular to the central axis;
an encoder side bracket coupled to the encoder and having an encoder side extension portion extending in the first direction;
a substrate bracket provided between the speed reducer side extension portion and the encoder side extension portion, coupled to the speed reducer side extension portion and the encoder side extension portion, and having a facing surface facing the motor;
a first substrate mounted on the facing surface; and
a second substrate mounted on a back surface that is a back side of the facing surface.

2. The drive device according to claim 1, wherein
the speed reducer is a wave gear speed reducer including a wave generator,
the motor includes
a speed reducer side bearing that rotatably supports the drive shaft on the one side, and
a motor casing that accommodates the drive shaft therein,
in the motor casing, the speed reducer side bearing is fitted from inside, and a protrusion that protrudes toward the speed reducer is provided, and
a recess which the protrusion enters is formed in the wave generator.

3. The drive device according to claim 1, wherein
the encoder includes
an encoder substrate on which a detection unit that detects a rotational position of the drive shaft is mounted, and
an encoder casing that supports the encoder substrate,
the motor includes an encoder side bearing that rotatably supports the drive shaft on the other side, and
the encoder side bearing is supported by the encoder casing.

4. The drive device according to claim 1, further comprising
a torque sensor fixed to an output shaft of the speed reducer and detecting torque applied to the output shaft, wherein
the torque sensor includes
a boss portion into which the output shaft is fitted,
an annular portion formed in an annular shape centered on the central axis and surrounding a periphery of the boss portion,
a plurality of beam portions connected to an outer peripheral surface of the boss portion and an inner peripheral surface of the annular portion and formed side by side at equal intervals in a circumferential direction around the central axis, and
a strain detection unit that detects strain of the beam portion, and
a thickness of the beam portion in a direction along the central axis is smaller than thicknesses of the boss portion and the annular portion.

5. The drive device according to claim 4, wherein
a through hole penetrating the outer peripheral surface and an inner peripheral surface is formed in the boss portion,
a penetrating portion penetrating an outer peripheral surface and the inner peripheral surface is formed in the annular portion, and
the penetrating portion is formed at a position where the through hole is projected onto the annular portion along a penetrating direction.

6. The drive device according to claim 5, wherein
when viewed along the central axis, an extending direction of the beam portion and the penetrating direction of the through hole are shifted from each other,
an inner peripheral surface protrusion protruding toward the boss portion is formed at a portion between the plurality of beam portions on the inner peripheral surface of the annular portion, and
a thickness of the inner peripheral surface protrusion is larger than the thickness of the beam portion.

7. The drive device according to claim 1, wherein
the second substrate is a controller substrate that generates a drive command for driving the motor based on a detection result of the encoder, and
the first substrate is a driver substrate that transmits current to the motor based on the drive command.

8. A joint device comprising:
at least two drive devices according to claim 1 coupled in parallel to the central axis, wherein
a cylindrical portion having a cylindrical shape coaxial with the drive shaft is formed outside the encoder side bracket, and
the joint device further comprises:
an external bearing having an inner ring and an outer ring, the cylindrical portion being fitted inside the inner ring;
a first coupling bracket that couples an output shaft of the speed reducer of the one drive device and a speed reducer side extension portion of the other drive device; and
a second coupling bracket that couples the external bearing of the one drive device and an encoder side extension portion of the other drive device.

9. The joint device according to claim 8, wherein
either the first substrate or the second substrate of the one drive device is a controller substrate that generates a drive command for driving the motor based on a detection result of the encoder,
the one drive device further includes
a torque sensor applied to the drive shaft, and
a wiring connected to the controller substrate and the torque sensor of the one drive device, and
the wiring is connected from the torque sensor to at least one of the first substrate and the second substrate of the one drive device via the first coupling bracket, the speed reducer side extension portion of the other drive device, the encoder side extension portion of the other drive device, the second coupling bracket, and the encoder side bracket of the one drive device.

10. A gripping device comprising:
the joint device according to claim 8; and
a gripping portion connected to the other drive device.

11. A gripping device comprising:
the drive device according to claim 4; and
a gripping portion connected to the torque sensor,
extending toward the one side, and having a gripping surface facing the central axis.
